(19) United States
(12) Patent Application Publication
(10) Pub. No.: US 2023/0398615 A1
(43) Pub. Date: Dec. 14, 2023

(54) BLADE TENSIONING SYSTEM AND GAUGE FOR A BAND SAW

(71) Applicant: JPW INDUSTRIES INC., LaVergne, TN (US)

(72) Inventors: Timothy Gale Birdwell, Lafayette, TN (US); Jeffery Lee Konkle, Murfreesboro, TN (US); Charles Weber, Onalaska, WI (US); Yi-Feng Fang, Taichung City (TW)

(21) Appl. No.: 18/209,029

(22) Filed: Jun. 13, 2023

Related U.S. Application Data
(60) Provisional application No. 63/351,649, filed on Jun. 13, 2022.

(51) Int. Cl. B23D 55/10; B23D 55/02; B23D 55/08; B23D 59/00

(52) U.S. Cl. CPC B23D 55/10; B23D 55/02; B23D 55/082; B23D 59/001

(57) ABSTRACT

A band saw is disclosed that includes a frame, a guide wheel, and a blade disposed around the guide wheel. A guide wheel chassis can be movably disposed on the frame, the guide wheel rotatably disposed on the guide wheel chassis. The band saw can include a blade tension adjustment assembly including a tensioning motor, wherein operation of the tensioning motor produces movement of the guide wheel chassis and the guide wheel relative to the frame to adjust the tension of the blade. A tension gauge can be positioned to determine a tension in the blade, and a controller can be communicated with the tensioning motor and the tension gauge, the controller operable to receive tension data from the tension gauge and control operation of the tensioning motor based on the tension data to control the tension of the blade.

### CROSS-REFERENCES TO RELATED APPLICATIONS

This application claims the benefit of U.S. Provisional Application Ser. No. 63/351,649 filed on Jun. 13, 2022 and titled “Blade Tensioning System And Gauge For A Band Saw,” which is incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to band saws and tensioning the blades in such bandsaws.

More particularly, the present disclosure relates to using a device to adjust the tensioning of a blade in a band saw. In some conventional devices manual adjustment devices are provided, where the blade guide wheels can be mounted to a movable chassis that can be moved using a manual screw device, such as the device taught in U.S. Pat. No. 7,594,462. Prior art devices can include a load cell coupled to the movable chassis and operable to effectively measure the force applied between the guide wheel via the movable chassis and a frame of the band saw, which is representative of the tension in the blade which applies a force onto the guide wheel.

Prior art systems utilized a manual screw adjustment to move the position of the guide wheel and thus adjust the tension in the band saw. Such devices require the band saw to be stopped and in some cases housing components to be removed to access the blade adjustment screw/knob, which is cumbersome. The prior art devices included a load cell for measuring the tension in the blade and a display for showing the tension, but if the tension slacked over time the device would have to be stopped to perform the adjustment mechanism. Manually adjusting the tension in the blade also requires a substantial amount of force, which could be difficult to provide with a manual force applied to the adjustment screw.

What is needed then are improvements to band saws and blade tension adjustment mechanism provided therein.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present invention is a band saw including a frame, a guide wheel, a blade disposed around the guide wheel, and a guide wheel chassis movably disposed on the frame, the guide wheel rotatably connected to the guide wheel chassis. The band saw can include a blade tension adjustment assembly including a tensioning motor, wherein operation of the tensioning motor produces movement of the guide wheel chassis and the guide wheel relative to the frame to adjust the tension of the blade. A tension gauge can be engaged with the guide wheel chassis and operable to determine a tension in the blade. A controller can be communicated with the tensioning motor and the tension gauge, the controller operable to receive tension data representative of the tension in the blade from the tension gauge and control operation of the tensioning motor based on the tension data to control the tension of the blade. In some embodiments, the controller can be operable to adjust the tension of the blade during operation of the band saw while the blade is spinning.

In some embodiments, the band saw can further include a display communicated with the controller, the display including a user interface for receiving tension input commands from a user, the controller operable to control the tensioning motor based on the received tension input commands from the user. In some embodiments, the user interface can allow a user to create saw blade size and blade tension presets or profiles for easy access when changing blades for conventional or often used saw blades.

While any suitable blade tensioning and tension gauge structures can be utilized in the band saw of the present disclosure with a tensioning motor for driving movement of the guide wheel chassis, in some embodiments the frame can include a frame guide block rigidly mounted to the frame, the tensioning motor include a drive shaft threadingly engaged with the frame guide block. The guide wheel chassis can further include a pair of guide rods moveably extending through the frame guide block, the guide rods each having a first end and second end. A motor platform can be positioned on a first end of the guide rods, the tensioning motor mounted to the motor platform. A retention plate can be positioned on a second end of the guide rods. A wheel guide structure can be slidably disposed on the guide rods between the frame guide structure and the retention plate, the guide wheel rotatably connected to the wheel guide structure. A spring can be positioned between the retention plate and the wheel guide structure, the tension gauge positioned between the spring and either the retention plate or the wheel guide structure such that the spring applies a force on the tension gauge substantially equal to the tension in the blade.

The use of a motorized tensioning assembly can allow for more efficient and automated tensioning of the blade, because the tensioning can be done without having to manually turn knobs and open up saw housings etc. The tensioning can also be done while the saw is operational as manual adjustment has been removed. Thus, the band saw of the present disclosure can help reduce down time for the saw due to adjusting the tension in and/or changing blades.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a perspective view of an embodiment of a band saw of the present disclosure having an outer housing removed to show an internal guide wheel and blade tensioning assembly

FIG. 2 is a perspective view of the band saw of FIG. 1 with the guide wheel removed to see the blade tensioning assembly.

FIG. 3 is a detailed view of the blade tensioning assembly of FIG. 2

FIG. 4 is a schematic diagram of a control circuit for the band saw of FIG. 2.

FIG. 5 is a flow chart diagram of an embodiment of a method of changing a blade and tensioning the blade adjustment method of the present disclosure using the tensioning adjustment mechanism.

FIG. 6 shows screen shots of an embodiment of a progression of user interface screens when adjusting the tension in and/or changing blades on a band saw of the present disclosure.

FIG. 7 shows screen shots of another embodiment of user interface screens of adjusting the tension in the blade of a band saw of the present disclosure.

FIG. 8 shows screen shots of an embodiment of a progression of user interface screens when selecting and/or creating preset blade profiles for use with a band saw of the present disclosure.

FIG. 9 shows screen shots of an embodiment of a progression of user interface screens once the blade is selected and the system goes through a tracking and tensioning process.

FIG. 10 shows an embodiment of a user interface screen when the band saw is running allowing the user to monitor and adjust the tension in the blade, and stop the band saw with a manual input as needed.

FIG. 11 is a detailed view of another embodiment of a blade tensioning assembly of the present disclosure using a rotary gauge as the tension gauge.

FIG. 12 is a detailed view of another embodiment of a blade tensioning assembly of the present disclosure using a linear gauge as the tension gauge.

FIG. 13 is a detailed view of another embodiment of a blade tensioning assembly of the present disclosure using a flex sensor between a guide wheel structure and a retention plate of the blade tensioning assembly as the tension gauge.

FIG. 14 is a detailed view of another embodiment of a blade tensioning assembly of the present disclosure using a strain gauge as the tension gauge.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

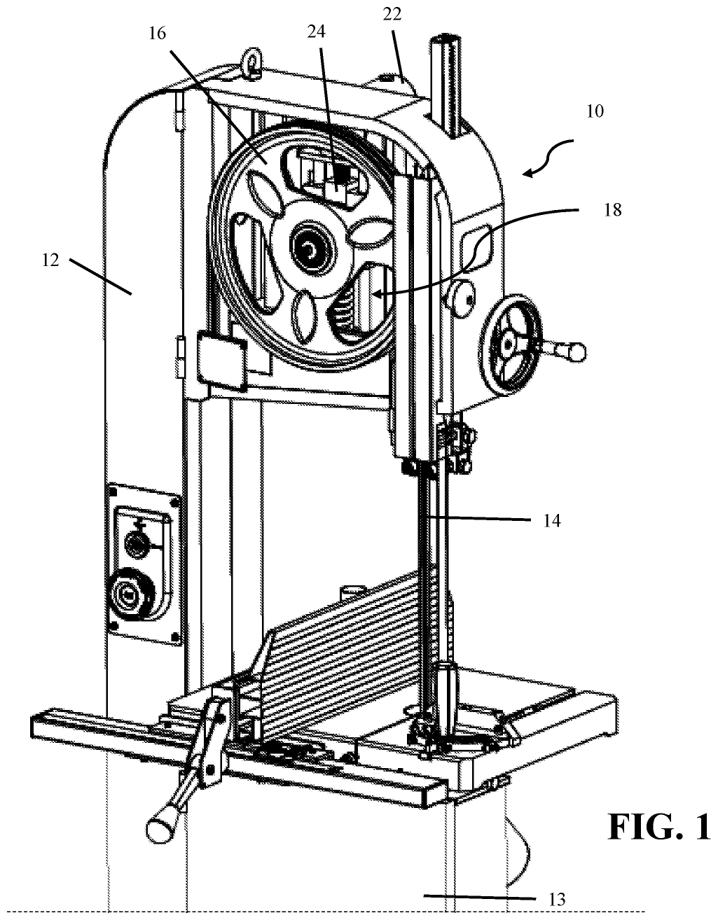

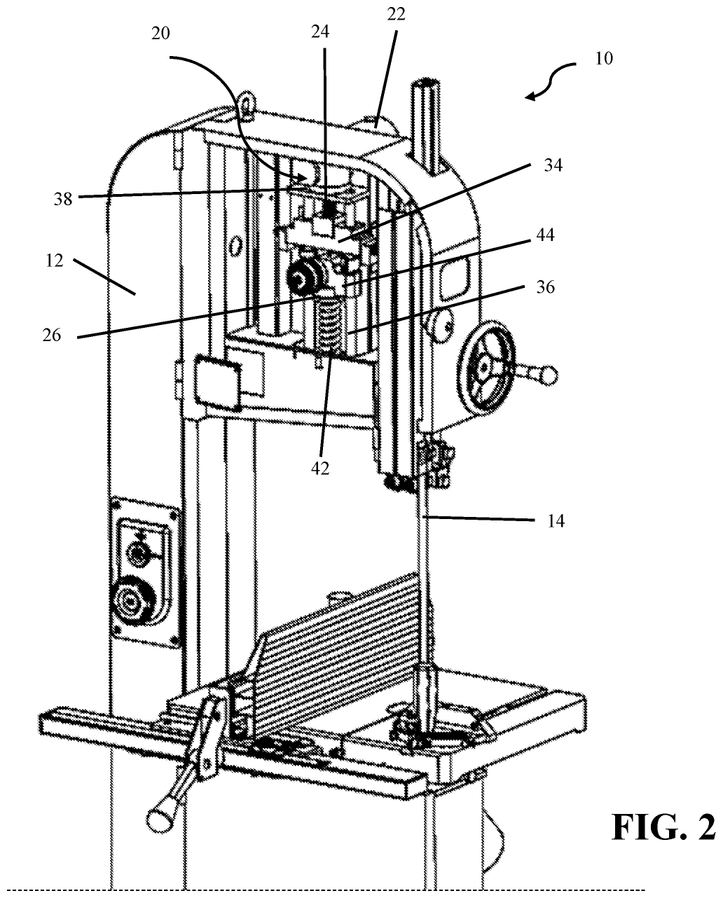

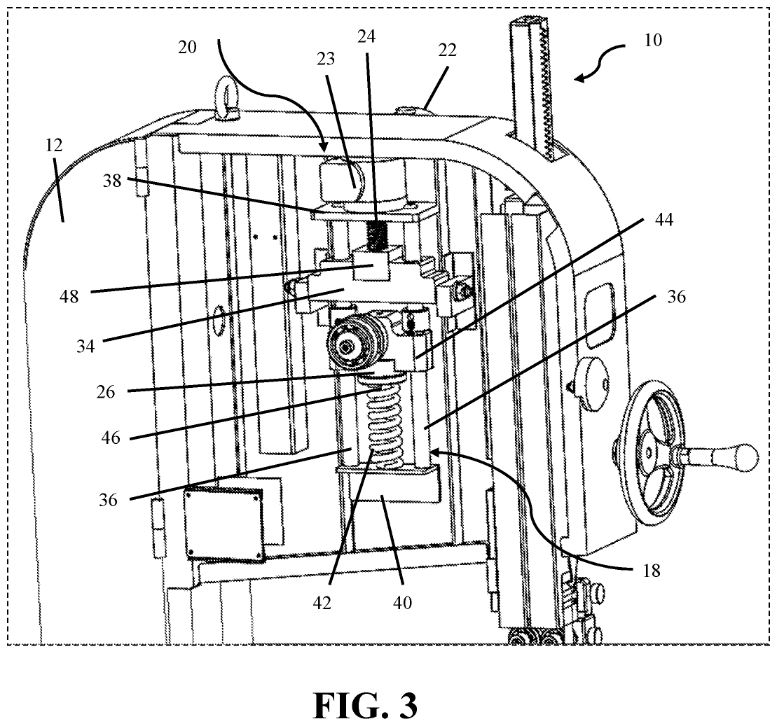

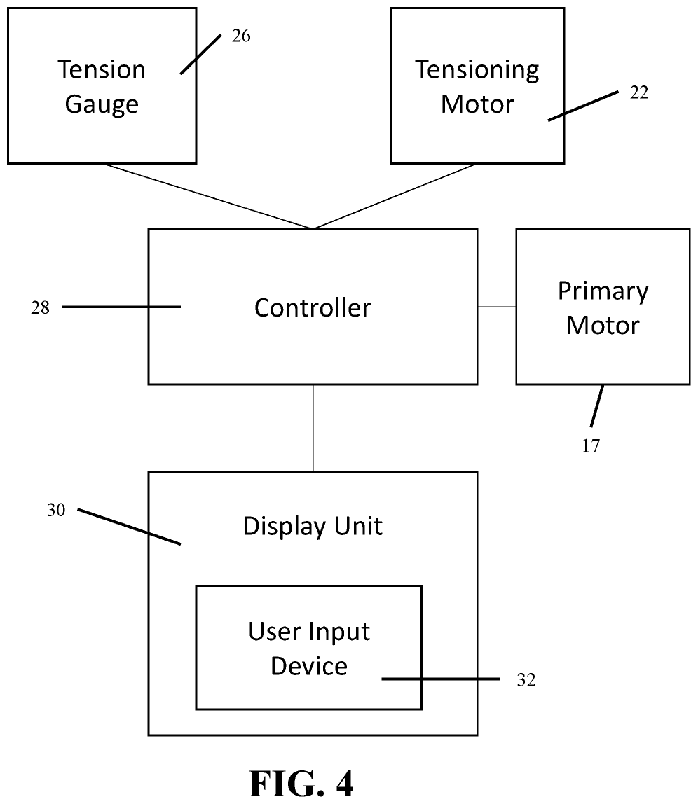

An embodiment of a band saw 10 of the present disclosure is shown in FIGS. 1-4. Generally, a band saw 10 can include a frame 12, at least two guide wheels rotatably disposed on the frame 12 about which a blade 14 can be disposed and tensioned. One guide wheel (not shown) can be a driver guide wheel which can be coupled to a primary motor 17 (the driver guide wheel and primary motor 17 are inside the lower base 13 of the frame 12 in FIG. 1) for the band saw 10. The primary motor 17 can drive the driver guide wheel which can in turn drive the blade 14 for the sawing operation. The secondary guide wheel 16 can rotate due to the engagement between the secondary guide wheel 16 and the blade 14 and maintain tension in the blade 14 due to the separation between the driver guide wheel and the secondary guide wheel 16. “Guide wheels” referred to herein and include either the driver guide wheel or the secondary guide wheel 16. In some prior art band saws, the position of either the driver guide wheel or the secondary guide wheel 16 can be adjustable relative to the frame 12 to adjust the tension in the blade 16, in order to maintain proper engagement between the blade 14 and the wheels. While it will be discussed herein that the secondary guide wheel 16 is adjustable relative to the frame 12, which in many cases is easier to design so the primary motor 17 and drive wheel can remain stationary, in some embodiments, the same wheel adjustment and blade tensioning systems and methods taught herein can be incorporated on the driver guide wheel side of the band saw 10 to achieve similar functionality.

One aspect of the present invention is a band saw with an improved blade tensioning and gauge system. The band saw 10 can include a frame 12, a guide wheel 16, a blade 14 disposed around the guide wheel 16, and a guide wheel chassis 18 movably disposed on the frame 12, the guide wheel 16 rotatably connected to the guide wheel chassis 18. The band saw 10 can include a blade tension adjustment assembly 20 including a tensioning motor 22, in some embodiments including a threaded drive shaft 24, wherein operation of the tensioning motor 22 produces movement of the guide wheel chassis 18 and thus the guide wheel 16 relative to the frame 12 in order to adjust the tension of the blade 14. A tension gauge 26 can be oriented to determine a tension in the blade 14. In some embodiments, the tension gauge 26 can be engaged within the guide wheel chassis 18 of the band saw 10 and operable to determine a tension in the blade 14. A controller 28 can be communicated with the electric tensioning motor 22 and the tension gauge 26, the controller 28 operable to receive tension data from the tension gauge 26 and control operation of the tensioning motor 22 based on the tension data to control the tension of the blade 14. The tension gauge 26 can be any suitable device for measuring an equivalent force substantially equal to the tension in the blade 14, or for indirectly measuring the tension in the blade, as discussed in more detail herein. For instance, in some embodiments, the tension gauge can include, but is not limited to, a load cell, strain gauge, flex sensor, rotary gauge, linear gauge, etc.

In other embodiments, a servo motor can be used for the tensioning motor 22 of the band saw 10. As tension in the blade 14 increases, the load on the servo motor 22 can increase to drive the blade tension adjustment assembly 20 under the increased tension. Thus, the servo tensioning motor 22 can be used to monitor the tension in the blade 14 as opposed to a separate load cell or other tension gauge structure, such that the tensioning motor 22 can also act as the tension gauge 26. The controller 28 can be programmed to monitor load outputs from the tensioning motor 22, associate or correlate such load outputs with an equivalent tension in the blade 14, and adjust the positioning of the guide wheel 16 accordingly utilizing the tensioning motor 22 as the tension gauge 26.

In some embodiments, the controller 28 can be operable to adjust the tension of the blade 14 during operation of the band saw 10 while the blade 14 is spinning. For instance, as the band saw 10 operates the blade 14 can heat up causing the blade 14 to expand, which can decrease the tension in the blade 14. The blade 14 can also stretch over time, or the guide wheels 16 can be subject to wear or deformation, again decreasing the tension in the blade 14. The controller 28 can continuously monitor for these tension changes via the tension gauge 26 and control the motor 22 to adjust the tension as needed. As such, operation of the band saw 10 does not need to be stopped to adjust the tension in the blade 14, which provides a significant improvement in the performance and adjustment capabilities of the band saw compared to systems with manual adjustment mechanisms. In some embodiments, the controller 28 can be programmed to not decrease the tension in the blade 14 when an increase in the tension is observed for a short period of time, for instance in cutting curves and the blade is potentially bent slightly during use but returns to its normal shape post cut.

In some embodiments, the tension gauge 26 can be used to detect an emergency condition, such as a de-tensioning or breaking of the blade 14. The controller 28 can monitor for the tension decreasing below a predetermined emergency threshold during normal operation of the band saw 10 and shut down the band saw automatically if the emergency condition is detected. In such scenarios, the controller 28 immediately shutting off the band saw 10 can help reduce any injury to a user of the machine due to a broken or de-tensioned blade 14.

In some embodiments, the band saw 10 can include a manual tension quick release handle including a cam, which can be moved from an untensioned position to a tensioned position. When the quick release handle is moved from the untensioned position to the tensioned position, the cam passes an inflexion point wherein the tension in the blade 14 can retain the quick release handle in the tensioned position. The band saw 10 can further include a limit switch that is only closed when the manual tension quick release handle is in the full tensioned position. The quick release handle can be weighted and positioned such that if the blade breaks or runs off the wheel, such that blade tension on the cam of the quick release handle is removed, the weight of the handle will overcome the cam that raises the wheel to tension the blade, the handle will fall, and the limit switch will open up, stopping the motor. This mechanism can provide an additional safety feature to stop the motor of the band saw 10 if the blade 14 loses tension.

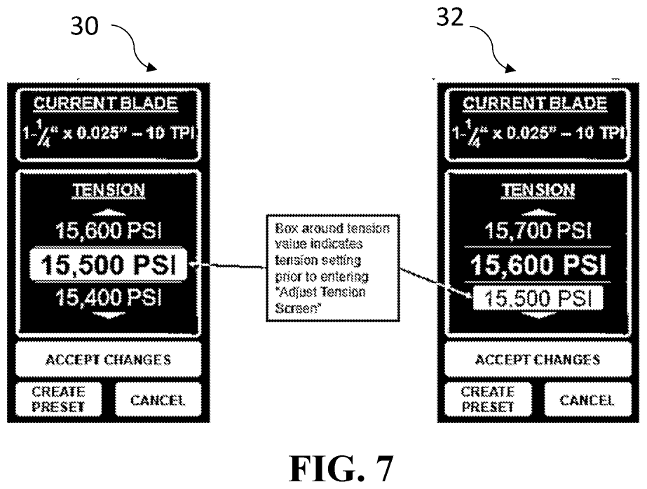

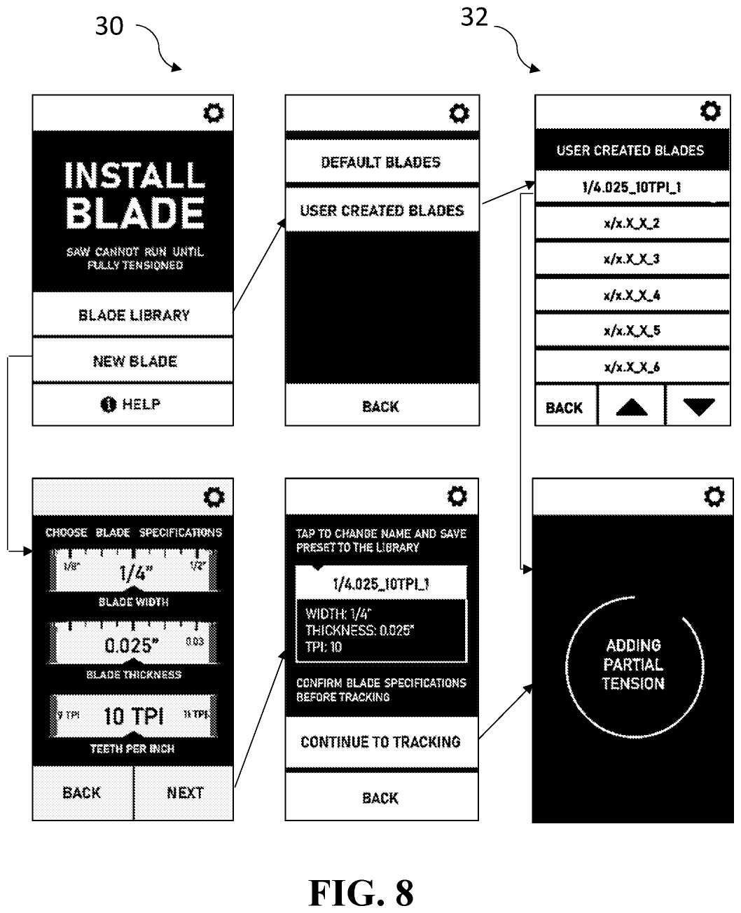

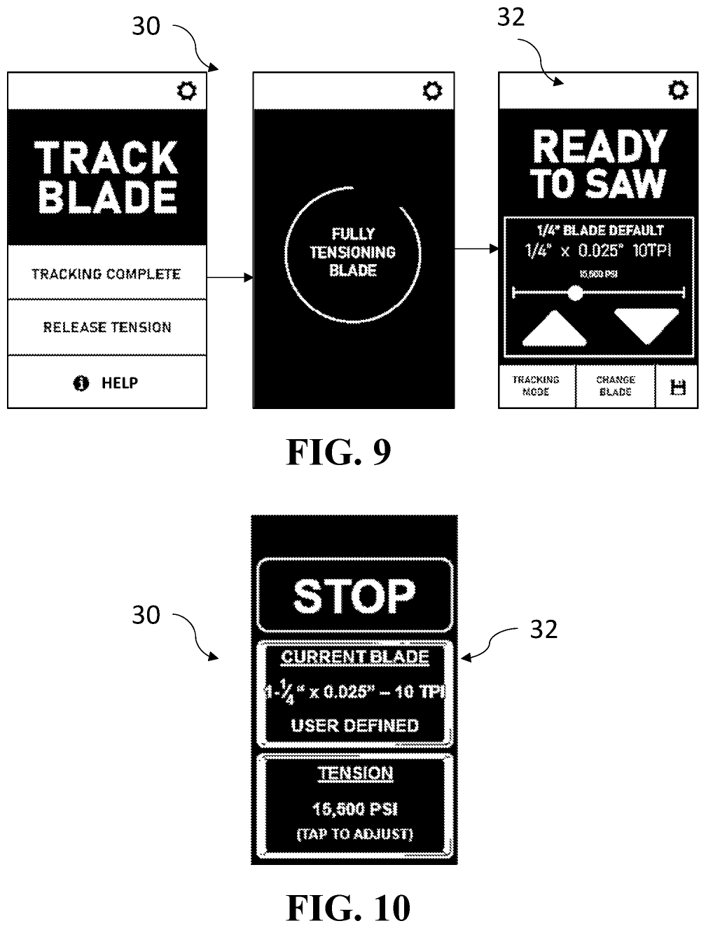

In some embodiments, the band saw 10 can further include a display 30 communicated with the controller 28, the display 30 including a user interface 32 for receiving tension input commands from a user, the controller 28 operable to control the tensioning motor 22 based on the received tension input commands from the user. In some embodiments, the user interface 32 can allow a user to create saw blade size and blade tension presets or profiles, as shown in FIG. 8, for easy access when changing blades for common or conventional saw blades. The blade presets can include, but are not limited to, blade thicknesses, widths, and default tension settings. FIG. 7 shows an embodiment of a user interface 32 screen where the user can scroll through common tension settings manually to set the tension for the blade. FIGS. 9 and 10 also show a user interface 32 screen during operation of the band saw 10 wherein the user can stop the band saw 10 or adjust the tension during operation. The user interface 32 and display unit 30 can generally be positioned on the frame 12 and communicated with the controller 20 from a positon easily accessible to the user before and during operation of the band saw 10. In some embodiments, the user interface 32 can be a digital touch screen, though the user interface 32 could be any suitable interface for receiving user input including a keypad, voice instruction system, etc. In some embodiments, the user interface 32 could also be a mobile application communicated with the controller 30.

Referring again to FIGS. 1-4, while any suitable blade tensioning and tension gauge structures can be utilized in the band saw 10 of the present disclosure with a tensioning motor 22 for driving movement of the guide wheel chassis 18, in some embodiments the frame 12 can include a frame guide block 34 rigidly mounted to the frame 12, the guide shaft 24 on the tensioning motor 22 threadingly engaged with the frame guide block 34. The frame guide block 34 in some embodiments can include a threaded nut 48 or a threaded bore into which the threaded drive shaft 24 can be received. The guide wheel chassis 18 can further include a pair of guide rods 36 moveably extending through the frame guide block 34, the guide rods 36 each having a first end and second end. A motor platform 38 can be positioned on a first end of the guide rods 36, the tensioning motor 22 mounted to the motor platform. A retention plate 40 can be positioned on a second end of the guide rods 36. A wheel guide structure 44 can be slidably disposed on the guide rods 36 between the frame guide block 34 and the retention plate 40, the guide wheel 16 rotatably connected to the wheel guide structure 44. A spring 42 can be positioned between the retention plate 40 and the wheel guide structure 44, the tension gauge 26 positioned between the spring 42 and the retention plate 40.

Because the wheel guide structure 44 is slidably disposed on guide rods 36, the force applied by the spring 42 on the wheel guide structure 44 (via the tension gauge 26) as the motor 22 moves the retention plate 40 is the force that moves the wheel guide structure 34 in an upward direction. The blade 14 will resist such a force such that the spring 42 can apply a force on the tension gauge 26 substantially equal to the tension force from the blade 14 on the guide wheel 16. As such, the force applied by the spring 42 on the tension gauge 26 can be used to measure the tension of the blade 14.

In some embodiments, the tension gauge 26 can include a load cell operable to measure a direct force applied on the load cell 26 via the spring 42. In other embodiments, the guide wheel chassis 44 can be threadingly coupled to the drive shaft 24 of the motor 22. In such embodiments, the drive shaft 24 can be directly engaged with the load cell 26 such that as the blade 14 is tensioned, the drive shaft 24 can produce a force on the load cell 26 equal to the tension force in the blade 14.

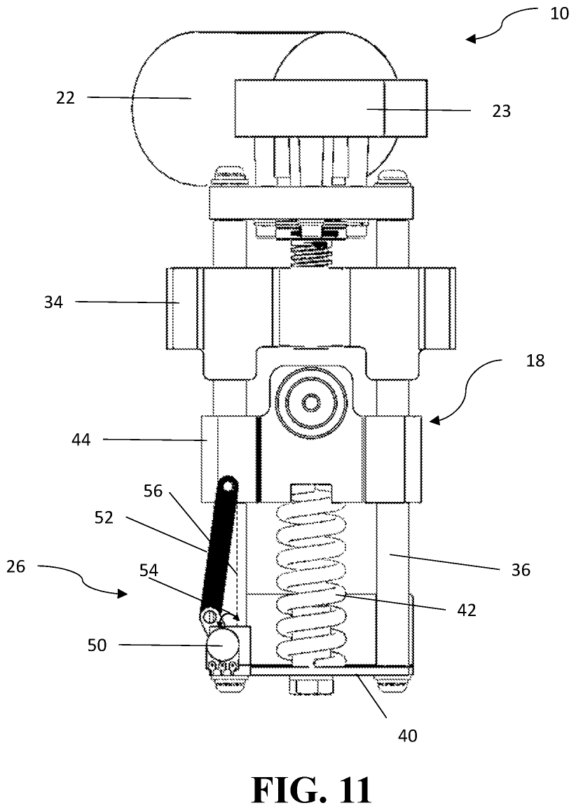

In still other embodiments, the tension gauge 26 can indirectly measure the tension in the blade 14, for instance by measuring the change in dimension or deflection in one or more components of the band saw 10 or blade tensioning assembly and correlate or calibrate that measurement with a tension in the blade 14. For instance, as shown in FIGS. 11-13, a tension gauge 26 can be oriented to measure the change in length or compression/stretch on the spring 42, such that the stretch or compression of the spring 42 can be monitored and correlated to different tensions in the blade 14 using Hooke's law to determine the force in the spring 42 equivalent to the tension in the blade 14.

In some embodiments, as shown in FIG. 11, a rotary tension gauge 50 such as a rotary potentiometer 26a can be utilized to determine a length of the spring 42. The rotary potentiometer 50 can be connected to the retention plate 40, and a connection linkage 52 can be pivotally connected to the arm of the potentiometer 50 and a point on the wheel guide structure 44 at the same vertical height as the connection point between the spring 42 and the wheel guide structure 44. In such embodiments, the length of the arm of the potentiometer 50 and the connection linkage 52 are fixed. As the motor 22 is operated and the spring 42 is compressed or stretch, the change in length of the Spring 42 causes the angle between the arm of the potentiometer 50 and the connection linkage 52 to change, and thus the angle 54 between the arm of the potentiometer 50 and a vertical reference axis representative of the length of the spring 42 to change. The change in the angle 54 can be measuring using the potentiometer. Using the law of cosines, the length 56 of the spring 42 can be calculated as the rotary potentiometer 50 monitors the change in the angle 54 and the fixed lengths of the arm of the potentiometer 50 and the connection linkage 52. The length of the spring 42 can then be used to indirectly determine the force in the spring 42 and thus the tension of the blade using Hooke's law.

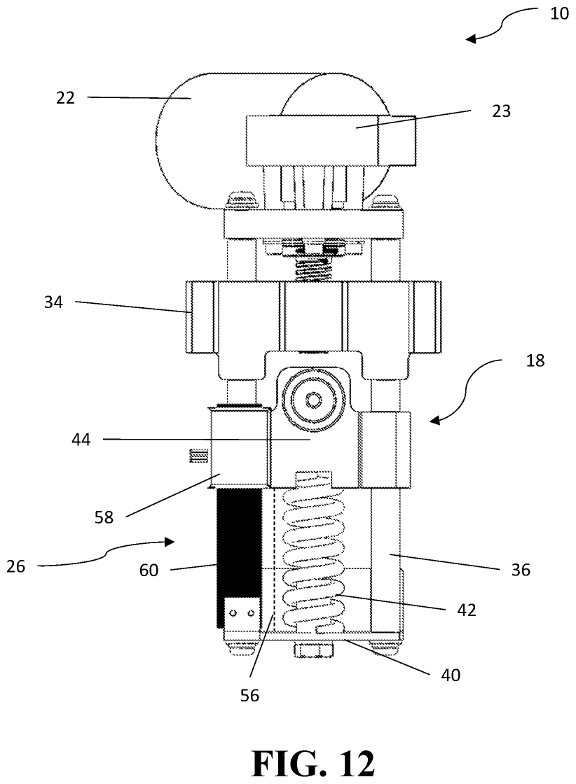

In other embodiments, as shown in FIG. 12, a linear tension gauge 58 can be used to determine the length of the spring 42. A linear track 60 can be mounted between the retention plate 40 and the wheel guide structure 42. As the motor 22 is operated and the spring 42 is compressed or decompressed, the linear gauge 58 be mounted to the wheel guide structure 44 and ride along the linear track 60. The linear gauge 58 can interface with the linear track 60 via capacitive, optical, magnetic, or other suitable sensing technologies to determine a position of the linear gauge relative to the linear track 60 and thus the length 56 or change in length of the spring 42. The length 56 of the spring 42 can again be used to calculate the force in the spring 42 and thus the tension in the blade.

In still other embodiments, a pneumatic pressure gauge can be used which can be oriented to be compressed as the tension in the blade 14 increases. The pressure in the gauge can be calibrated to correlate to varying tensions in the blade 14. While several types of suitable tension gauges 26 have been described herein, any suitable tension gauge 26 for determining the tension in the blade 14 either directly or indirectly can be utilized.

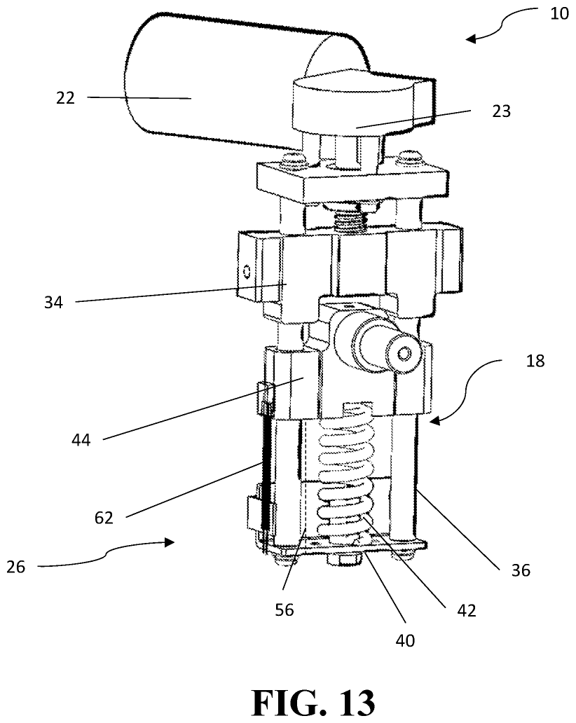

In still other embodiments, as shown in FIG. 13, a flex sensor 62 can be utilized as the tension gauge 26. The flex sensor 62 can be connected between the wheel guide structure 44 and the retention plate 40 such that as the spring 42 is compressed or decompressed the flex sensor 62 will flex or unflex. The amount of flex monitored by the flex sensor 62 can be calibrated and correlated to the change in length of the spring 42 and thus the tension in the blade.

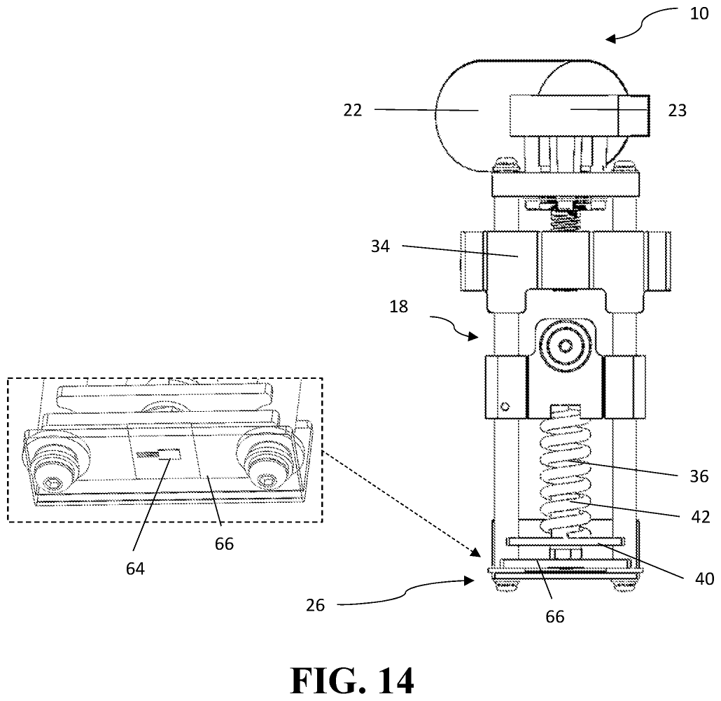

In still other embodiments, as shown in FIG. 14, the tension gauge 26 can be a strain gauge 64 positioned to determine the tension in the blade. The strain gauge 64 can include a deformable plate 66 positioned to receive a strain force from the spring 42 in a direction normal to the plate 66 which can cause the plate 66 to flex. The strain gauge 64 can measure the flex of the plate 66 and correlate that flex to the force of the spring 42 and thus the tension of the blade. In some embodiments, the strain gauge 64 can be directly coupled to the retention plate 40 such that the retention plate acts as the deformable plate for the strain gauge 64.

In some embodiments, as shown in FIGS. 1 and 11, to reduce the overall height and footprint of the band saw 10, the motor 22 can extend out of a side (or front or back) of the frame 12 and rotate on a horizontal axis, and a worm gear or beveled gear system 23 can be utilized to redirect the rotation of the motor 22 to a second drive shaft rotation along a vertical axis to cause vertical movement of the guide wheel 16. In such embodiments the drive shaft 24 can include both the horizontal and vertical threaded or non-threaded drive shafts and the associated redirectional gear system 23.

As the tensioning motor 22 is operated, the threaded drive shaft 24 will engage the frame guide block 34. Because the frame guide block 34 is fixedly connected to the frame 12, and the tensioning motor 22 is prevented from rotating via motor platform 38 (and guide rods 36 extending through the frame guide block 34), the rotation of the drive shaft 24 will cause the motor 22 and thus the guide rods 36 and retention plate 40 to move with the motor 22. In tensioning the blade 14, the motor 22 can move in an upward direction relative to the frame guide block 34, thereby moving the guide rods 36 and the retention platform in an upward direction. This upward movement further compresses the spring 42 which forces the guide wheel 16 upward which such that the tension in the blade 42 increases to balance this increased force from the spring 42. Similarly, to reduce the tension of the blade 14, the motor 22 can be operated in the reverse direction to lower the motor 22, guide rods 36, and retention plate 44, in order to release the compression of the spring 42, lower the guide wheel 16, and thus reduce the tension in the blade 14.

In some embodiments, guidepost 46 can extend between the tension gauge 26 and the retention plate 40 and through the spring 42 such that the guidepost 46 can maintain the spring 42 in a desired location within the guide wheel chassis 18. In some embodiments the guidepost 46 can extend from the retention plate 40 and through the spring 42. In other embodiments, the guidepost 46 can extend from the tension gauge 26 or the wheel guide structure 44.

The figures in this application show an embodiment wherein the motor 22 is above the wheel guide structure 44 and the frame guide block 34 such that the motor 22 can move upward and away from the frame guide block 34 to pull the retention plate 44 and the guide wheel 16 in an upward direction. In some embodiments the motor 22 can be positioned below the wheel guide structure 44 on the lower retention plate 40 and threadingly engaged with the frame guide block 34, such that the motor 22 can move upward with the retention plate 40 in operation toward the frame guide block 34 to move the retention plate 40 and the guide wheel 16 upward to tension the blade.

In still other embodiments, similar to the structure shown in U.S. Pat. No. 7,594,462, the motor drive shaft 24 can extend through the wheel guide structure 44 and/or the guide wheel chassis 18 and be threadingly engaged with a threaded nut or the tension gauge 26 directly, such nut or tension gauge being restricted from rotation by either the wheel guide structure 44 or some other structure of the guide wheel chassis 18 and the spring 42 can be positioned between the wheel guide structure 44 and the threaded nut or tension gauge 26. As the motor is operated, the threaded nut or the tension gauge 26 could move along the drive shaft 24, thus compressing or releasing compression in the spring 42 to change the force applied on the wheel guide structure 44 by the spring 42, and thus the tension in the blade 14.

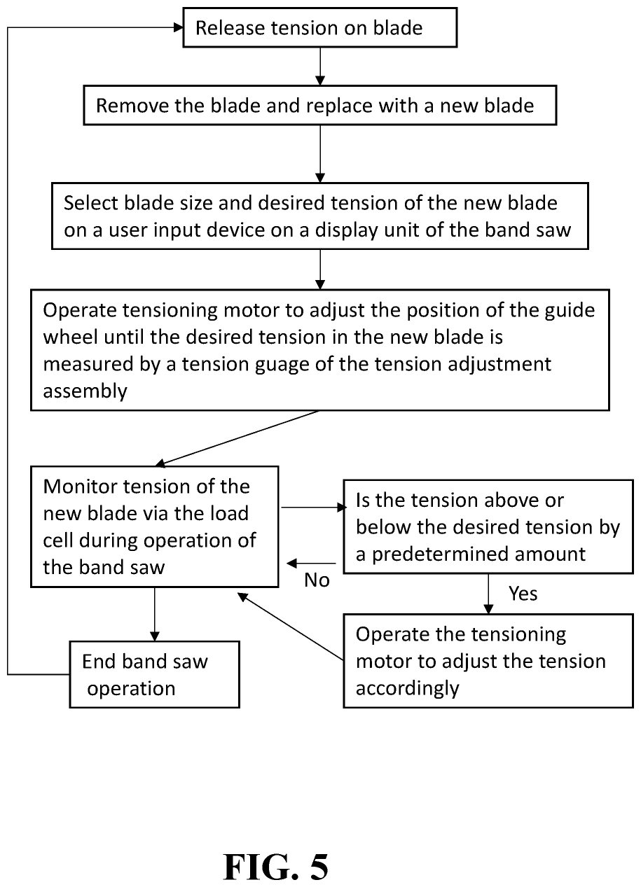

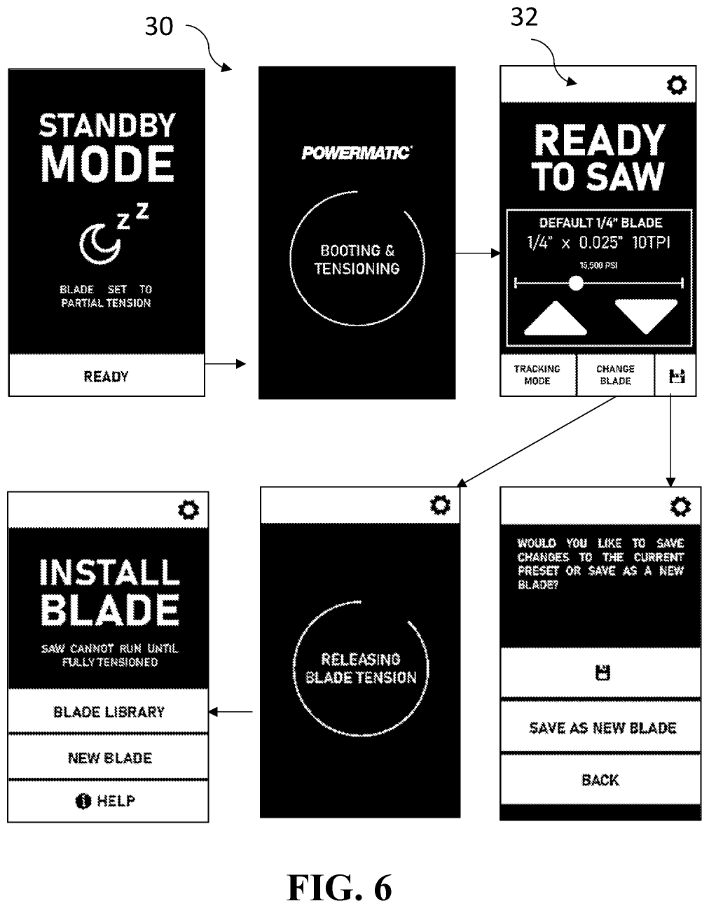

A method of changing a blade and monitoring the tension of the blade during operation can be seen in FIGS. 5-9. The user can select using the user interface 30 an option to change the blade. The tensioning motor 22 can then be programmed to remove all tension from the blade and provide sufficient slack for the user to change the blade. The user can then remove the old blade and place a new blade on the drive and guide wheels. The user can then select the blade specification from a supplied list or input new parameters for a new blade profile as needed. The motor 22 can then apply partial tension to the blade. The user can be instructed to verify and adjust the blade for proper tracking on the driver and secondary guide wheels, and to properly set the blade guides. Once the user confirms tracking and blade guides are set correctly the band saw can be set to full tension for the selected blade. The tension gauge 26 can then monitor the tension of the blade when the band saw 10 is running during operation, and if the tension varies more than a predetermined amount, the controller 28 can adjust the tension in the blade via the tensioning motor 22 as needed.

In some embodiments, the controller 28 can be programmed to recognize when the saw remains inactive for a user configurable or preset period, and once that idle state is reached the motor will partially release the tension to prevent flat spots or deformation of the guide wheel and/or blade stretch. If the user presses the START button or otherwise powers up the band saw 10 during the partial tension state, the tensioning motor will apply full tension before allowing the primary drive motor to start.

Thus, although there have been described particular embodiments of the present invention of a new and useful BLADE TENSIONING SYSTEM AND GAUGE FOR A BAND SAW, it is not intended that such references be construed as limitations upon the scope of this invention.

What is claimed is:

1. A band saw comprising:
a frame;
a guide wheel;
a blade disposed around the guide wheel;
a guide wheel chassis movably disposed on the frame, the guide wheel rotatably disposed on the guide wheel chassis; and
a blade tension adjustment assembly including:
a tensioning motor, wherein operation of the tensioning motor produces movement of the guide wheel chassis and the guide wheel relative to the frame to adjust the tension of the blade; and
a tension gauge positioned to determine a tension in the blade; and
a controller communicated with the tensioning motor and the tension gauge, the controller operable to receive tension data from the tension gauge and control operation of the tensioning motor based on the tension data to control the tension of the blade.

2. The band saw of claim 1, wherein the controller is operable to cause the tensioning motor to adjust the tension of the blade during operation of the band saw.

3. The band saw of claim 1, further comprising a display communicated with the controller, the display including a user interface for receiving tension input commands from a user, the controller operable to control the tensioning motor based on the received tension input commands from the user.

4. The band saw of claim 3, wherein the controller includes a plurality of preset blade profiles, each blade profile including a blade width and a blade thickness, and the controller is operable to control the tension of the blade based on a user selecting one of the plurality of preset blade profiles.

5. The band saw of claim 3, wherein the display is operable to receive a change blade command, wherein when the change blade command is received, the controller causes the tensioning motor to release the tension in the blade.

6. The band saw of claim 1, wherein
the frame includes a frame guide block rigidly mounted to the frame, the tensioning motor guide including a drive shaft threadingly engaged with the frame guide block; and
the guide wheel chassis further comprises:
a pair of guide rods moveably extending through the frame guide block, the guide rods each having a first end and a second end, the tensioning motor coupled to the first ends of the guide rods;
a retention plate connected to the second ends of the guide rods;
a wheel guide structure slidably disposed on the guide rods between the frame guide structure and the retention plate, the guide wheel rotatably connected to the wheel guide structure; and
a spring positioned between the retention plate and the wheel guide structure.

7. The band saw of claim 6, wherein when the motor is operated the motor moves relative to the frame guide block, which moves the retention plate to adjust the force applied on the spring and thus the tension in the blade.

8. The band saw of claim 7, wherein the tension gauge is positioned between the spring and the wheel guide structure such that the spring applies a force on the tension gauge substantially equal to the tension in the blade.

9. The band saw of claim 6, further comprising a motor platform positioned on a first end of the guide rods, the tensioning motor mounted to the motor platform such that the tensioning motor is coupled to the first ends of the guide rods via the motor platform.

10. The band saw of claim 6, further comprising a guidepost extending from the retention plate through the spring.

11. The band saw of claim 1, wherein the tensioning motor extends outward through the frame of the band saw.

12. The band saw of claim 1, wherein the tension guide is a load cell positioned to receive a force from one or more components of the band saw that is equal to the tension in the blade.

13. The band saw of claim 1, wherein the tension gauge and controller are operable to detect an emergency condition in the tensioning of the blade and stop the band saw when such emergency condition is detected.

14. The band saw of claim 1, wherein the controller is operable to determine that the band saw has been idle for a predetermined period of time and release a portion of the tension on the blade until the band saw is operated again.

15. A band saw comprising:
a frame;
a guide wheel;
a blade disposed around the guide wheel;
a guide wheel chassis movably disposed on the frame, the guide wheel rotatably disposed on the guide wheel chassis; and
a blade tension adjustment assembly including:
a tensioning motor including a threaded drive shaft, wherein operation of the tensioning motor produces movement of the guide wheel chassis and the guide wheel relative to the frame to adjust the tension of the blade; and
a tension gauge positioned to receive a force from the guide wheel chassis equal to the tension in the blade; and
a controller communicated with the tensioning motor and the tension gauge, the controller operable to receive tension data from the tension gauge and control operation of the tensioning motor based on the tension data to control the tension.

16. The band saw of claim 15, wherein
the frame includes a frame guide block rigidly mounted to the frame, the tensioning motor guide shaft threadingly engaged with the frame guide block; and
the guide wheel chassis further comprises:
a pair of guide rods moveably extending through the frame guide block, the guide rods each having a first end and a second end, the tensioning motor coupled to the first ends of the guide rods;
a retention plate connected to the second ends of the guide rods;
a wheel guide structure slidably disposed on the guide rods between the frame guide structure and the retention plate, the guide wheel rotatably connected to the wheel guide structure; and
a spring positioned between the retention plate and the wheel guide structure.

17. The band saw of claim 16, wherein the tension gauge is operable to measure the length of the spring and correlate the length of the spring with the tension in the blade.

18. The band saw of claim 17, wherein the tension gauge includes a rotary gauge and positioned between the retention plate and the wheel guide structure and oriented to measure the length of the spring.

19. The band saw of claim 17, wherein the tension gauge includes a linear gauge positioned between the retention plate and the wheel guide structure and oriented to measure the length of the spring.

20. A band saw comprising:
a frame;
a guide wheel;
a blade disposed around the guide wheel;
a guide wheel chassis movably disposed on the frame, the guide wheel rotatably disposed on the guide wheel chassis; and
a blade tension adjustment assembly including:
a tensioning motor, wherein operation of the tensioning motor produces movement of the guide wheel chassis and the guide wheel relative to the frame to adjust the tension of the blade; and
a tension gauge positioned to determine a tension in the blade;
a controller communicated with the tensioning motor and the tension gauge, the controller operable to receive tension data from the tension gauge and control operation of the tensioning motor based on the tension data to control the tension during operation of the band saw; and
a display communicated with the controller, the display including a user interface for receiving tension input commands from a user, the controller operable to control the tensioning motor based on the received tension input commands from the user.
